(19) United States
(12) Patent Application Publication
(10) Pub. No.: US 2010/0171296 A1
(43) Pub. Date: Jul. 8, 2010

(54) PROTECTION DEVICE IN MOTOR VEHICLES FOR PROTECTING INDIVIDUALS

(76) Inventors: Stephan Rohner, Dortmund (DE); Mirko Janisch, Lohmar (DE); Jozef Lang, Budapest (HU); Michael Schulte, Olpe (DE); Hans Gerd Menne, Bergneustadt (DE); Frank Liesaus, Bergneustadt (DE)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(21) Appl. No.: 12/295,803

(22) PCT Filed: Apr. 3, 2007
(86) PCT No.: PCT/EP07/53250

§ 371 Date: Apr. 21, 2009

(30) Foreign Application Priority Data
Apr. 6, 2006 (DE) 10 2006 016 155.6

(51) Int. Cl. B60R 21/13; B60R 21/02

(52) U.S. Cl. 280/748; 280/756

(57) ABSTRACT

Protection devices in motor vehicles typically have a movable element, for example a roll bar (1) or a flap, which, in the initial state, is fixed in its position by a releasable holding device. In the event of a hazard, the movable element can be released under sensor control by a common pyrotechnic actuator (11) and can be deployed with the protection being activated. The protection device also has a means (8, 9) for locking the deployed, movable element. A driving pressure chamber (12, 15), which is fixed on the bodywork and in which a driving piston (2 with 13, 16) connected to the movable element is accommodated in a guided manner, is connected downstream of the pyrotechnic actuator (11). The protection device is designed with regard to the pyrotechnic release and erecting system in such a manner that, with as small a pyrotechnic charge as possible and a defined holding force which is not applied by additional holding elements, the movable element can obtain a very high kinetic energy even after just a few millimeters of extension travel. To accomplish this, a releasable connection is formed by a locally delimited, frictional and/or form-fitting and/or bonding direct connection (14) between the wall of the driving pressure chamber (12, 15) and the driving piston (2 with 13, 16). The direct connection has a releasable holding force which amounts to at least 300 N and at maximum 5000 N.

### CROSS-REFERENCE TO RELATED APPLICATIONS

This application is a Section 371 of International Application No. PCT/EP2007/053250, filed Apr. 3, 2007, which was published in the German language on Oct. 11, 2007, under International Publication No. WO 2007/113303 A1 and the disclosure of which is incorporated herein by reference.

### BACKGROUND OF THE INVENTION

The invention relates to a protection device in motor vehicles for protecting individuals, which has a movable element that, in its initial state, is fixed in its position by a releasable holding device formed by a releasable connection of the movable element to the vehicle. In the event of a dangerous situation, the protection device can be released under the control of sensors by a common pyrotechnic actuator and deployed with activation of the protection. The protection device has a device for locking the deployed, movable element, wherein a drive pressure chamber fixed to the vehicle by its walls is connected after the pyrotechnic actuator. A drive piston connected to the movable element is held in the pressure chamber in a guided way.

Reinforced protection devices for protecting individuals have been integrated into motor vehicles, which devices have two parts that can move relative to each other. In the initial state, when no danger is expected, these movable parts must be fixed in their mutual positions by a holding device and, in the event of a dangerous situation, they must be moved relative to each other with high acceleration, while releasing the holding device, and in the erected state must be partially locked against a retraction. These protection devices relate both to the protection of vehicle occupants and also to the protection of passersby.

Typical examples are the known rollover protection devices for convertibles for protecting the vehicle occupants with a telescoping rollover bar, which is fixed in the initial state in a lowered rest position by a holding device in a housing and which, in the event of a rollover, is deployed from the lowered rest position into a locked support position under the control of sensors by a then activated energy storage device. As representative of many publications, reference is made in this regard to German Patent DE 100 40 642 C2.

Another field of use includes active under-ride protection systems, as described, e.g., in German published patent application DE 103 16 847 A1. An active under-ride protection system typically has a deployable flap attached, especially for sport-utility vehicles, on the front end underneath the bumper. The flap is deployed by opening downward when there is an imminent frontal impact. With such a device height and contour differences between two vehicles can be equalized, in order to prevent a riding up of one of the impacting vehicles on the other.

Furthermore, typical examples are known devices for protecting passersby during a frontal impact on the front hood of the motor vehicle by active positioning of the front hood, especially in the region of the hood hinge, by an erecting element, also called an actuator. Such device is made from a housing fixed to the car body and a lifting element connected to the front hood and held in this housing, so that it can be deployed by an energy storage device. In the initial state, the lifting element is held by the holding device in the lowered rest position; in the event of a dangerous situation, it is erected under the control of sensors by releasing the holding device with a predetermined lift.

These devices for impact protection according to the principle of an active front hood are to protect passersby from especially severe injuries, i.e., pedestrians, whether they are children or adults or also bicycle riders or skaters, who are impacted by a motor vehicle and are thrown onto the front or engine hood, as well as against the windshield. Here, in particular, the head as well as the upper body of an adult pedestrian or bicycle rider is put at risk, because upon an impact with a motor vehicle—as crash tests and also experience have shown—these parts hit approximately in the rear, relatively hard area on the front hood at the transition to the windshield and in this way can be severely injured. The previously mentioned protection devices, as have become known, e.g., from German published patent application DE 197 12 961 A1, as representative of many publications, mitigate the previously mentioned hard transition area to the windshield by constructing it to be more flexible.

In this way, a deformation displacement of the car body is created that becomes effective in the sense of more favorable energy dissipation for a chest or head impact of a pedestrian, which provides for reduced deceleration of the head and chest and thus for lower risks of injury.

For locking the respectively deployed, movable element in the support position, in known protection or safety devices, separate devices constructed in different ways are provided. Typically, the locking device is formed by an elongated, toothed element in connection with a rotatably hinged catch.

The releasable holding devices typically have a holding element, which is connected to the movable element and which is in releasable active connection with a release member of an actuator activated under the control of sensors.

Here, it has become known to provide a common pyrotechnic actuator for releasing the holding device and for deploying the movable element. For this, we refer to German Patent DE 199 60 764 B4. Although in this case no deployment springs are provided, i.e., the movable element does not have to be held down in the initial state against the biasing forces of deployment springs, a holding device is provided, in order to avoid improper removal and unintentional movement of the movable element, e.g., due to unevenness in the road surface. Here, in the known case, the holding device is made from several components, e.g., in one embodiment, first, from a locking pin with an undercut flange that connects to the movable element and, second, with a locking collar fixed to the car body on the inner wall of the pyrotechnic actuator with movable locking hook for a releasable active engagement with the undercut on the locking pin. Another embodiment has a sliding block, which is held so that it is movable in a diffuser plate fixed to the car body and fixes this in position in the rest state by a borehole in a projection of the movable element.

The use of several components, which form the holding device, can result in incorrect function tracing back to an addition of the different tolerances. In addition, it can involve an expensive embodiment; due to pressure on costs in the automotive supplier industry. However, the call for economical systems becomes louder and louder.

Furthermore, the gas pressure up to the point in time of the release and continuing during the deployment of the movable element is nearly constant, i.e., the displacement/time curve of the erecting element has a nearly linearly increasing profile.

With the known system described above, it is furthermore not intended to generate a possibly high kinetic energy for small pyrotechnic charges in the actuator after only a few millimeters of extension displacement. This is also underscored by the fact that with the system shown in the previously mentioned German publication with overflow boreholes, it is operated in order to guarantee an earliest possible transition of the gas pressure.

### BRIEF SUMMARY OF THE INVENTION

The invention is based on the problem of constructing a protection device of the type designated at the outset with respect to the pyrotechnic release and deployment system, in such a way that with a pyrotechnic charge as small as possible and a defined holding force, which is not applied by additional holding elements, a very high kinetic energy can be provided to the movable element after only a few millimeters of extension displacement.

The solution of this problem is achieved for a protection device in motor vehicles for protecting individuals, which has a movable element that is fixed in its position, in the initial state, by a releasable holding device formed by a releasable connection of the movable element to the vehicle. In the event of a dangerous situation, the protection device can be released under the control of sensors by a common pyrotechnic actuator and can be deployed while activating the protection. The protection device has a device for locking the deployed, movable element, wherein a drive pressure chamber attached by its walls to the vehicle and in which a drive piston connected to the movable element held in a guided way is connected behind the pyrotechnic actuator. The protection device is characterized in that the releasable connection is formed by a direct, locally limited, non-positive (force) fit and/or positive (form) fit or material fit connection between the walls of the drive pressure chamber and the drive piston, wherein this connection has a holding force to be released, which amounts to at least 300 N and a maximum of 5000 N.

By the invention, a series of advantages is achieved:

Smaller pyrotechnic charges can be used, which has the result that lighter materials with thinner material cross sections can be selected. This leads, in turn, to significant cost advantages.

The pyrotechnic release and deployment system is very simple to realize and very resistant to incorrect releases.

The movable element experiences a high kinetic energy after only a few millimeters of extension displacement. Therefore, on the one hand, it is deployed very quickly and, on the other hand, it can punch through a rear window located in the erection path for use in a convertible with a closed roof, in order to reach the full erection travel.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a schematic, partially cut-away front view of a first embodiment of an active rollover bar protection system according to the invention in the initial state, which has a common pyrotechnic actuator for releasing the holding device and for erecting the rollover bar;

FIG. 2 is a similar view of the system according to FIG. 1, but in the erected state of the rollover bar;

FIG. 3 shows in three Fig. parts A, B, C, enlarged cut-out views from FIG. 1 for illustrating the holding device according to the invention constructed by a direct, locally limited, non-positive and/or positive fit or material fit connection between one leg of the bar and a pressure chamber tube in the form of a narrowed section (Fig. part 3A), that can be formed like a completely surrounding groove (Fig. part 3B), or like an only partially surrounding groove (Fig. part 3C);

FIG. 4 is a schematic front view of a second embodiment of the holding device according to the invention for an active rollover bar protection system analogous to FIG. 1 in the initial state, wherein the holding device is attached to an additional piston/cylinder unit for erecting the rollover bar;

FIG. 5 is a similar view of the system according to FIG. 4, but in the erected state of the rollover bar;

FIG. 6 shows in three Fig. parts A, B, C analogous to FIG. 3, enlarged cut-out views from FIG. 4 for illustrating the holding device attached to the additional piston/cylinder unit in the form of a completely surrounding (FIG. 3C), or only partially surrounding (FIG. 3B), or narrowed section or embossing (FIG. 3A);

FIG. 7 is a schematic view of a variant of the second embodiment according to FIG. 4 with a piston/cylinder unit in which the piston and cylinder no longer overlap starting at a predetermined erection height; and

FIG. 8 is a displacement-time diagram for illustrating the release and erection movement of the rollover bar for the holding device formed according to the invention in comparison to the prior art.

### DETAILED DESCRIPTION OF THE INVENTION

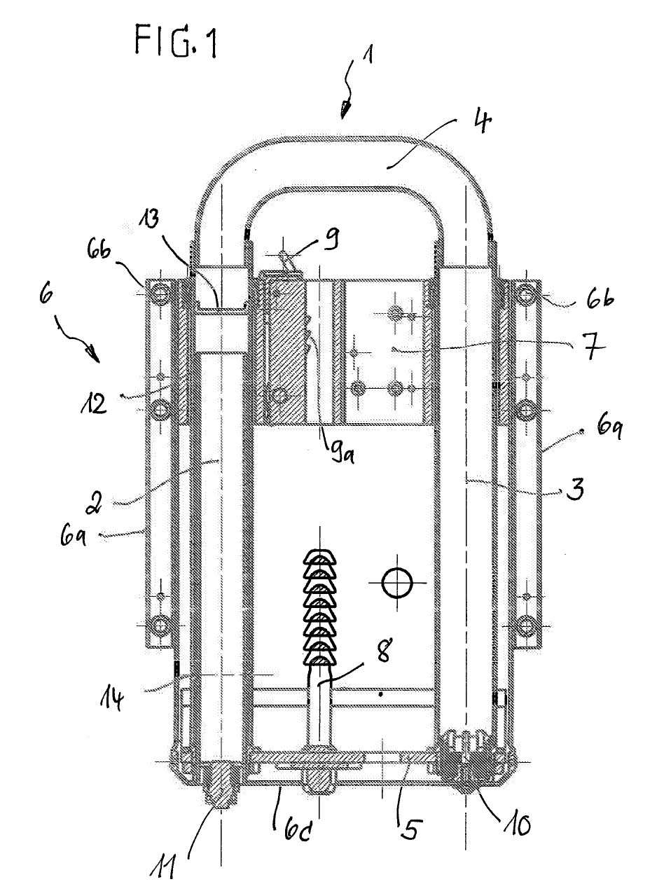

In FIGS. 1 to 7 the drawings show embodiments of the protection device according to the invention in the form of an active rollover protection system for protecting occupants in a convertible, in which the movable element is formed by a U-shaped rollover bar 1 with two parallel, tubular legs 2, 3 and a curved tubular crosspiece 4. The free ends of the legs 2, 3 are here connected in a reinforcing way by a traverse 5.

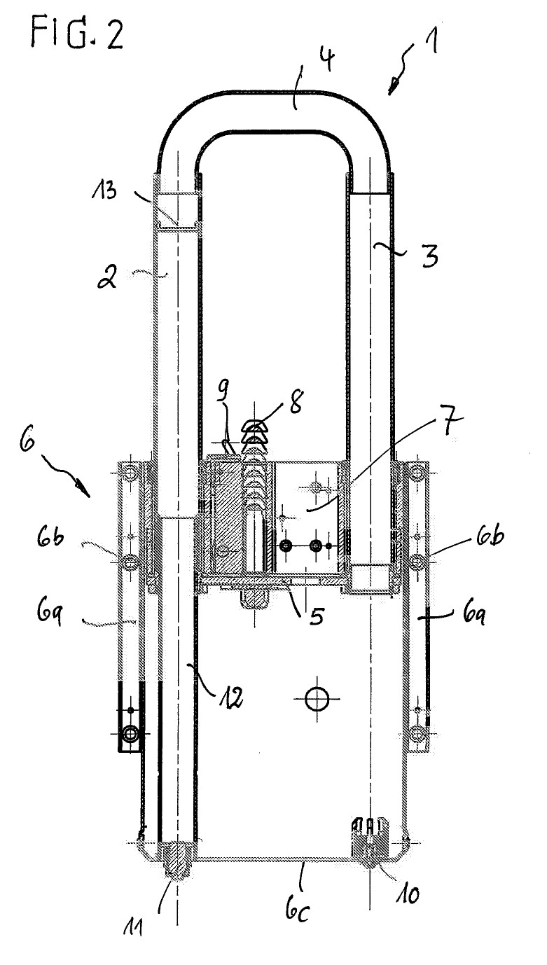

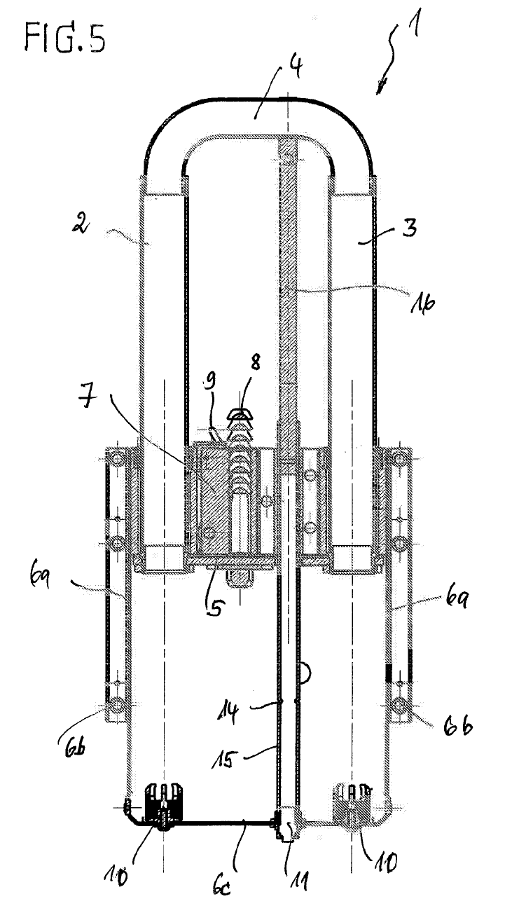

The rollover bar 1 is held in a guided way in a cartridge-like housing 6, which has side walls 6a with attachment holes 6b and a base 6c. For this purpose, in the upper region of the housing 6, a guide block 7 is attached that has guide openings for the legs 2, 3. On the traverse 5 a catch pin 8 is attached that connects to a catch hinged in the guide block so that it can rotate. Of these components, in the Figs., only the unlocking lever arm 9, to be activated manually, and also the teeth 9a for an active engagement with the undercut sections on the catch pin 8 are to be seen, which form the locking device of the retraction lock for the deployed rollover bar according to FIGS. 2 and 5. Furthermore, in the base 6c of the cartridge, lower guide elements 10 are attached to extending arms.

Such a rollover bar system is known and described in numerous patent specifications. Obviously, other known, comparable systems can also be used.

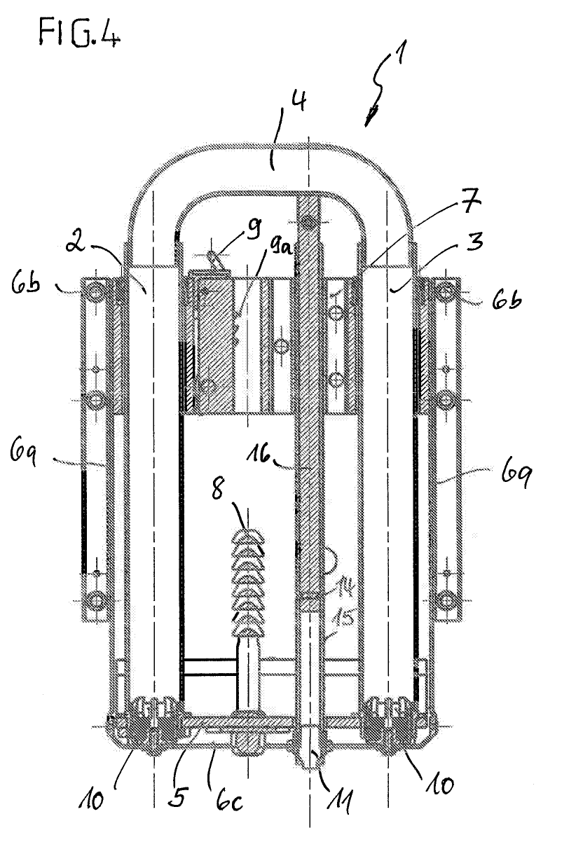

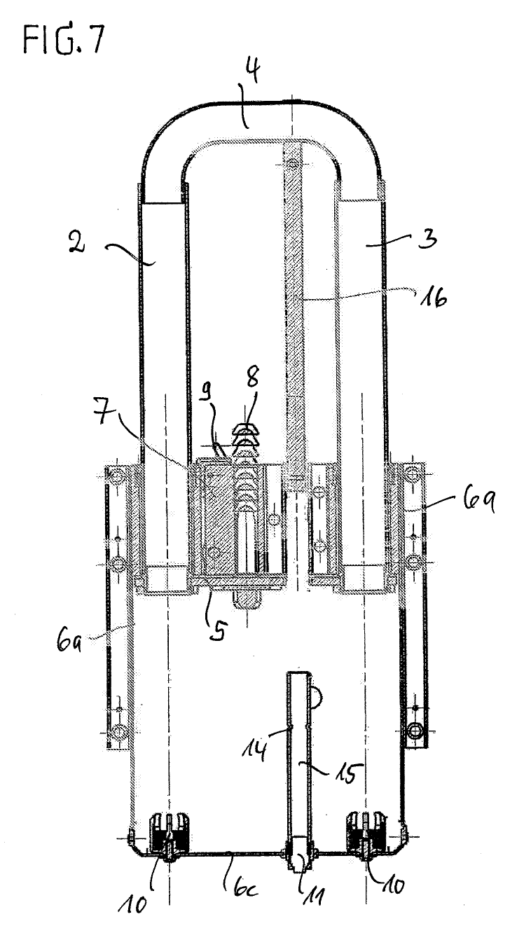

The invention relates to the construction of the holding device for fixing the position of the rollover bar in the initial state according to FIGS. 2 and 4 and the drive for rapid erection of the rollover bar. In FIGS. 1 to 3 a first variant is shown, and in FIGS. 4 to 6 a second variant is shown with a sub-variant in FIG. 7. In both cases, the release of the holding device and the erection should take place with a common pyrotechnic actuator. In the first variant, the erection is realized by the propellant gases of the actuator directly in the rollover bar 1 itself. For this purpose, a lower guide element 10 is provided only for the right leg 3, whereas in the region of the left leg 2 in the base 6c the common pyrotechnic actuator 11 is fixed in connection with a pressure chamber tube 12 projecting into the left leg 2 and also fixed in the base. So that the pressure building up in this pressure chamber tube after ignition of the pyrotechnic actuator 11 can erect the rollover bar, a sabot-like insert 13 is attached in the upper region of the left leg 2, preferably welded, namely at such a height that it lies in the retracted state according to FIG. 1 in the region of the outflow opening of the pressure chamber tube 12. Alternatively, the insert 13 could also be attached in the region of the free end of the right leg 3, sealing this tight, so that the pressure of the erecting propellant gases rises in the entire interior of the rollover bar.

Therefore, in the embodiment according to FIGS. 1-3, the erection of the rollover bar is realized differently than in the case of DE 199 60 764 B4 cited at the outset, i.e., without an additional cylinder tube and a piston rod. Instead, the rollover bar 1 itself is used with the associated insert 13 as the piston with variable piston space. The variability of the piston space can be achieved in that the insert 13, which acts as a piston base, sits at a certain distance from the pyrotechnic gas generator 11 matching the configuration of the bar.

The releasable holding device 14 is formed in the embodiment in a simple way by a groove-shaped narrowed section (embossed section) directly between the leg 2 and the pressure chamber tube 12, i.e., by a positive-fit (form fit) connection.

However, other positive-fit and/or non-positive-fit connections could also be provided, such as swaging, flanging, an interference fit, etc. Due to the pressure of the propellant gases, releasable material-fit connections are also conceivable. For a non-positive and positive-fit connection through swaging, narrowed sections, or flanging, material is driven from the stationary part into the erectable part. It is essential that the connection between the erection element, in FIGS. 1-3 the left leg tube, and the pressure chamber tube fixed to the vehicle be realized directly and locally limited, so that no additional parts are needed and the erection movement is not negatively affected after releasing the holding device.

The connection is here beneficially constructed, such that it continues to hold up to a certain holding force greater than 300 N.

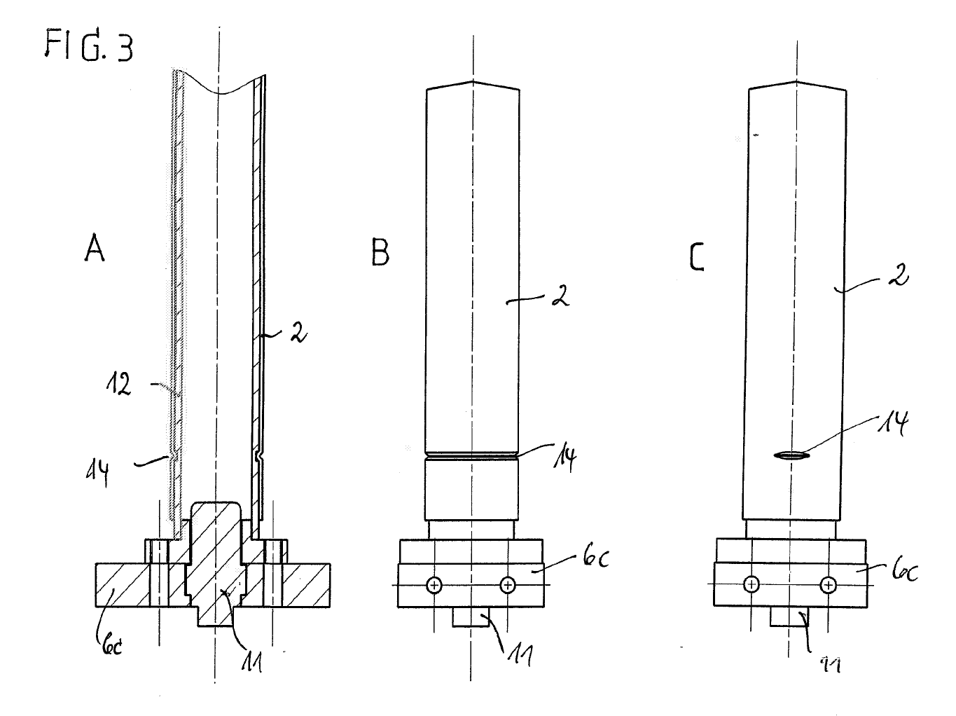

As FIG. 3 shows, the mechanical connection, here the narrowed section of the holding device 14, has a surrounding groove-like construction according to Fig. part 3B or only a partially surrounding groove-like construction according to Fig. part C.

In one sub-variant to the embodiment according to FIGS. 1-3, it is also conceivable to arrange the leg tube 2 inside the pressure chamber 12, wherein then the holding device 14 simultaneously acts as a seal. The leg tube can then be erected without a negative effect due to the connection 14 after it is “overcome.” To prevent this effect, for the embodiment according to FIG. 1 the pressure chamber 12 is, for example, narrowed or at least partially narrowed behind the positive-fit connection 14, if it involves only just a partial narrowing.

In FIGS. 4 to 7, a second embodiment of the invention is described with a sub-variant in FIG. 7. The illustrated rollover protection system here corresponds to that in FIG. 1. Therefore, all of the identical parts are provided with the same reference symbols and do not need to be explained in more detail here.

While in the first embodiment according to FIGS. 1 to 3 the erection piston is formed by the rollover bar, in the second embodiment according to FIGS. 4-7, a separate piston/cylinder unit, to which the holding device according to the invention is also attached, is provided for erecting the rollover bar 1. As can be recognized in FIGS. 4 and 5, an elongated cylindrical tube 15 is provided, which is attached to the base 6c of the cartridge-like housing 6, wherein, in the base itself, an opening is provided concentric to the cylindrical tube 15, in which the pyrotechnic actuator 11 is attached so that it can be replaced from the outside.

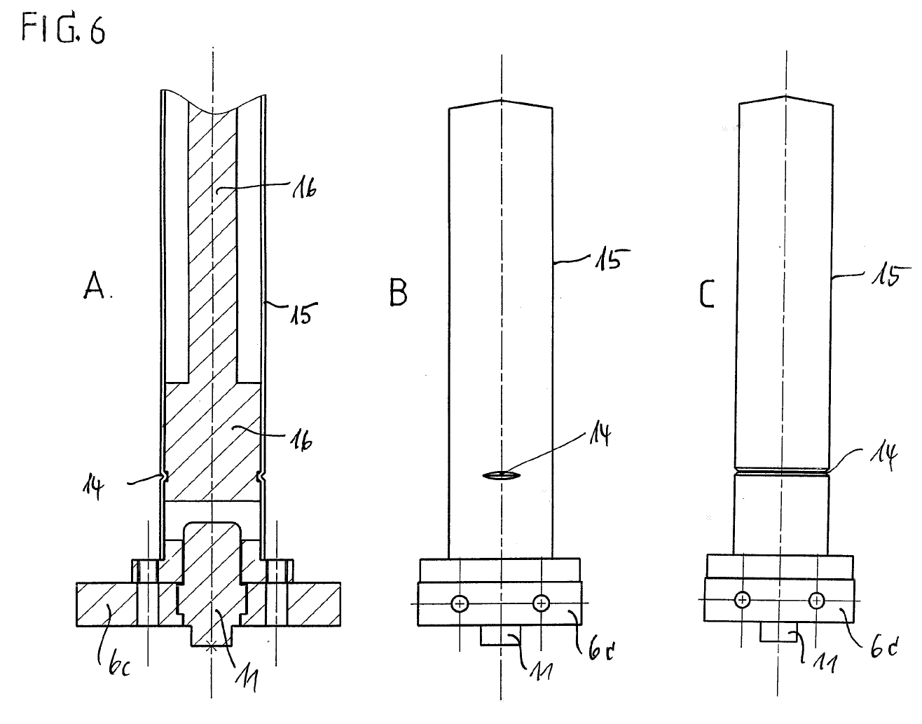

In the interior of the cylindrical tube 15, which acts as a drive cylinder, there is an elongated drive piston 16 guided in a sliding way, which is attached with its top end to the crosspiece 4 of the rollover bar 1. In an analogous way, as in the first embodiment, the holding device 14, as FIG. 6A particularly shows, is formed by a groove-like pressing between the cylindrical tube 15 and the drive piston 16, which gives a certain retaining or releasing force. For this positive-fit or non-positive-fit and optionally also material-fit connection which forms the releasable holding device, this applies accordingly for the holding device 14 of the first embodiment. The groove-like narrowed section can therefore have a completely surrounding construction (Fig. part 6C) or only a partially surrounding construction (FIG. 6B).

The piston rod 16 and the cylinder tube 15 do not have to remain engaged over the entire path until locking. It is definitely conceivable that the clamping surface of the piston rod and cylinder tube is released at a certain point, but the kinetic energy is nevertheless sufficient to lock the rollover bar 1 in a supporting position. Such an embodiment is shown in FIG. 7.

In the manufacturing process, the pyrotechnic erecting unit can be assembled as follows: First the pyrotechnic gas generator 11 having the pressure chamber 15 is assembled on the stationary part of the system; then the erecting element, the drive piston 16, located on the telescoping rollover bar 1 is brought into the pressure chamber. Then, both parts are connected to each other with a non-positive/positive or material fit, so that the holder of the system is produced.

The piston/cylinder unit 15, 16 is preferably constructed as a replacement part, which can be easily replaced after a release that has a destructive effect with respect to the holding device. For this purpose, the previously mentioned unit is preferably constructed as a plastic unit, which can be manufactured economically by injection-molding parts. Aluminum parts or steel parts or a combination of different materials could also be provided.

The function of the holding device according to the invention in comparison to the closest prior art and the achieved, advantageous effects are as follows:

1. Action in a conventional holding device, which should normally have the smallest possible retaining force, so that a reliable release is performed.

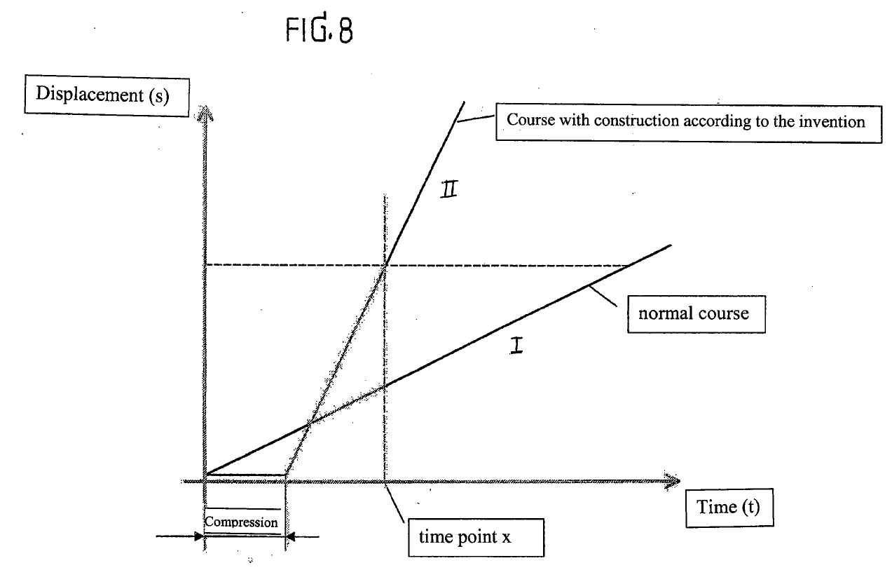

After ignition of the pyrotechnic gas generator, a pressure builds up continuously (in the millisecond range) in the pressure chamber. As soon as the holding device is released and the product from the pressure x affected surface is greater than the mass of the bar (which is represented as a force to be overcome), this bar is set in motion. This has the result that the deployment rate and thus the kinetic energy reach their maximum only at the end of the extension displacement. The associated displacement/time curve I in FIG. 8 runs relatively flat and is continuously linear with the same (small) slope.

2. Action in the holding device according to the invention with a relatively high release force, which is greater than 300 N but should not exceed the value of 5000 N.

After ignition of the pyrotechnic gas generator 11, the gas is initially compressed in the pressure chamber 12 or 15 until the holder 14, which has a retaining force greater than 300 N, is released. Therefore, in the displacement-time diagram of the erection movement according to curve II in FIG. 8, there is no record of movement up to this point in time. When the holder 14 is released, the now greatly compressed gas produces an abrupt erection movement, which is represented as a very steep line in the displacement-time diagram.

With the use of the same charge without such resistance, this line would be significantly flatter and the kinetic energy at low extension heights (e.g., at the height of the rear window) would be significantly lower.

The holding device (holder) according to the invention, which to some extent utilizes the “cartridge effect” (shot flanged in a cartridge sleeve) has the effect that a maximum kinetic energy for the rollover bar can already be made available after a very short displacement and a very short time. Thus, immediately after release, a high kinetic energy is available, which is already in position to punch through a window after a short travel. These conditions are also clear from the displacement/time diagram according to FIG. 8.

The steeper line II shows that the rollover bar passes through a larger displacement range in the same time slice, i.e., the velocity is greater (the slope of the line is proportional to the velocity, i.e., the tangent of the rising angle corresponds to the velocity).

The higher velocity has the effect of higher kinetic energy (E=M×V²/2) and thus also higher impact energy, which acts on the rear window and results in breaking this window.

In the illustrated embodiments, U-shaped rollover bars are shown. The subject matter of the invention, however, can also be used for profiled bars (cartridge systems). In particular, for extruded aluminum profiles, the provided hollow spaces can be used for a pressure chamber with drive pistons or also for rollover bars that are made from fiber composite or a hybrid (combination of different materials, such as plastic with steel, etc.)

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1-10. (canceled)

11. A protection device in a motor vehicle for protecting individuals, comprising:
a movable element (1) which, in an initial state, is fixed in its position;
a releasable holding device (14) formed by a releasable connection for fixing the movable element (1) to the vehicle;
a pyrotechnic actuator (11) which, in an event of a dangerous situation, releases and deploys the movable element under control of sensors to activate protection;
a locking device (8, 9) for fixing the movable element when deployed;
a drive pressure chamber (12, 15) connected after the pyrotechnic actuator (11) and fixed by its walls to the vehicle, the drive pressure chamber having a drive piston (2 with 13, 16) attached to the movable element and held in a guided way;
wherein the releasable connection is a direct, locally limited connection (14) selected from non-positive, positive and/or material fit direct connection between the walls of the drive pressure chamber (12, 15) and the drive piston (2 with 13, 16), and
wherein the releasable connection has a releasable retaining force, which amounts to at least 300 N and a maximum of 5000 N.

12. The protection device according to claim 11, wherein the direct connection (14) comprises direct swaging between the walls of the drive pressure chamber (12, 15) and the drive piston (2 with 13, 16).

13. The protection device according to claim 11, wherein the direct connection (14) comprises a narrowed section with an at least partially surrounding groove construction between the walls of the drive pressure chamber (12, 15) and the drive piston (2 with 13, 16).

14. The protection device according to claim 11, wherein the direct connection (14) comprises flanging between the walls of the drive pressure chamber (12, 15) and the drive piston (2 with 13, 16).

15. The protection device according to claim 11, wherein the movable element comprises a U-shaped rollover bar (1) having two tubular legs (2, 3) and a connecting crosspiece (4).

16. The protection device according to claim 15, wherein the drive piston is formed by one of the tubular legs (2) in connection with a sabot insert (13), and the drive pressure chamber is formed by a pressure chamber tube (12) fixed to the vehicle and projecting into the one tubular leg (2).

17. The protection device according to claim 15, comprising a piston/cylinder unit separate from the tubular legs, the piston/cylinder unit having the drive piston (16) connecting to the crosspiece (4) and a cylinder tube (15) as the drive pressure chamber connected to the pyrotechnic actuator and fixed to the vehicle, wherein the local, direct connection (14) is formed between the cylinder tube (15) and the drive piston (16).

18. The protection device according to claim 17, wherein the piston/cylinder unit is formed as a replaceable component.

19. The protection device according to claim 17, wherein the cylinder tube (15) and the drive piston (16) of the piston/cylinder unit are formed as plastic injection-molded parts.

20. The protection device according to claim 17, wherein the cylinder tube (15) has a length selected in relation to a length of the enclosed drive piston (16), such that the cylinder tube and the drive piston overlap only over a predetermined initial distance during deployment of the rollover bar (1).
